(19) United States
(12) Patent Application Publication
(10) Pub. No.: US 2007/0134024 A1
(43) Pub. Date: Jun. 14, 2007

(54) IMAGE FORMING APPARATUS AND IMAGE FORMING METHOD

(75) Inventors: Shigeharu OKANO, Ishikawa (JP); Hideaki Shibata, Ishikawa (JP); Hironaga Hongawa, Ishikawa (JP)

Correspondence Address: LOWE HAUPTMAN BERNER, LLP, 1700 DIAGONAL ROAD, SUITE 300, ALEXANDRIA, VA, 22314, US

(73) Assignee: PFU LIMITED, ISHIKAWA (JP)

(21) Appl. No.: 11/556,014

(22) Filed: Nov. 2, 2006

(30) Foreign Application Priority Data
Dec. 13, 2005 (JP) 2005-359269

(51) Int. Cl. G03G 15/10

(52) U.S. Cl. 399/249

(57) ABSTRACT

An image forming apparatus employs a liquid toner having nonvolatile high-viscosity silicon oil as a carrier fluid to form a toner image. The image forming apparatus includes a removing unit that removes a predetermined amount of carrier fluid contained in the toner image to thereby obtaining a carrier-fluid removed toner-image, a transfer unit that transfers the carrier-fluid removed toner-image onto an image forming medium; and a fixing unit that fixes the carrier-fluid removed toner-image on the image forming medium to the image forming medium.

### BACKGROUND OF THE INVENTION

1. Field of the Invention

The present invention relates to an image forming apparatus and an image forming method for transferring a toner image formed by a liquid toner having nonvolatile high-viscosity silicon oil as a carrier fluid onto an image forming medium and for fixing the toner image on the image forming medium.

2. Description of the Related Art

In an image forming apparatus, a transfer unit transfers a toner image onto an image forming medium, such as a paper medium, and a fixing unit heats the paper medium thereby fixing the toner image on the paper medium. The fixing unit includes a pair of heatable fixing rollers. The fixing rollers are arranged such that they are in contact with each other and exert a predetermined pressure on each other. Thus, a nip portion is formed between the fixing rollers. The fixing rollers are heated and a paper medium, on which the toner image is present, is passed through the nip portion. A heat for melting the toner image is transferred to the toner image on the paper medium that is passing through the nip portion, and at the same time, a pressure for making the melted toner image adhere and penetrate into the paper medium is applied to the toner image on the paper medium. With this mechanism, the toner image generates a required fixing strength (an adherence strength to the paper medium and a plastic strength), and becomes solidified to form a smooth and clear color material layer on the paper medium, to form an image on the paper medium.

With such a fixing unit, it is necessary to melt the toner image in a short time, for example, a few tens of milliseconds. Therefore, the fixing unit is required to heat the paper medium to a temperature appropriate for melting the toner image, i.e., an appropriate melting temperature, which means that it is required to heat the pair of fixing rollers to a temperature higher than the appropriate melting temperature. However, the appropriate melting temperature is apt to change according to quality of the paper medium, such as paper quality, thickness, and moisture content. For instance, the paper medium is thin, an offset phenomenon may occur, in which the melted toner image adheres to the fixing roller. On the other hand, when the paper medium is thick or has high moisture content, for example, melting of the toner image on the paper medium may become insufficient, resulting in a poor fixing or a formation of a low chromogenic image.

In the conventional image forming apparatus, to prevent a high temperature offset in particular, a release agent is applied on the toner image on the paper medium and the pair of fixing rollers, as shown in, for example, Japanese Patent No. 2928556. The image forming apparatus disclosed in the above literature employs a liquid toner (developing fluid), using a silicon oil as a carrier fluid for the liquid toner and the release agent for the fixing roller. The image forming apparatus disclosed in the above literature suppresses an adherence of the toner image to the fixing roller by applying the silicon oil on the fixing roller.

However, the image forming apparatus disclosed in the above literature requires a mechanism for applying the silicon oil on the fixing roller. In addition, the silicon oil applied on the fixing roller also adheres to the toner image transferred onto the paper medium. Therefore, the silicon oil adhered to the toner image causes an image of an unnatural glossiness to be formed on the image forming medium, which degrades the quality of the image. Furthermore, the silicon oil applied on the fixing roller adheres to a portion of the paper medium other than the transferred toner image, leaving a feeling of an oily sheen on the paper medium.

### SUMMARY OF THE INVENTION

It is an object of the present invention to at least partially solve the problems in the conventional technology.

According to one aspect of the present invention, an image forming apparatus includes a removing unit that removes a predetermined amount of carrier fluid contained in a toner image thereby obtaining a carrier-fluid removed toner-image, the toner image being formed by a liquid toner having nonvolatile high-viscosity silicon oil as the carrier fluid; a transfer unit that transfers the carrier-fluid removed toner-image onto an image forming medium; and a fixing unit that fixes the carrier-fluid removed toner-image on the image forming medium to the image forming medium.

According to another aspect of the present invention, an image forming method includes removing a predetermined amount of carrier fluid contained in a toner image thereby obtaining a carrier-fluid removed toner-image, the toner image being formed by a liquid toner having nonvolatile high-viscosity silicon oil as the carrier fluid; transferring the carrier-fluid removed toner-image onto an image forming medium; and fixing the carrier-fluid removed toner-image on the image forming medium to the image forming medium.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an image forming apparatus according to an embodiment of the present invention;

FIG. 2 is an enlarged view of a photosensitive unit shown in FIG. 1;

FIG. 3 is a flowchart of a process of forming an image performed by the image forming apparatus shown in FIG. 1;

FIG. 4 is a schematic diagram for illustrating a state of a liquid toner when passing a bias blade;

FIG. 5 is a schematic diagram for illustrating a state of the liquid toner at a developing time;

FIG. 6 is a schematic diagram for illustrating a state of a toner image on an image supporting roller at a carrier removing time;

FIG. 7 is a schematic diagram for illustrating a state of the toner image on a paper medium at a transferring time; and

FIG. 8 is a schematic diagram for illustrating a state of the toner image on the paper medium at a fixing time.

### DETAILED DESCRIPTION OF THE PREFERRED EMBODIMENTS

Exemplary embodiments of the present invention will be explained in detail below with reference to the accompanying drawings. The present invention is not to be considered limited to the exemplary embodiments. Furthermore, the constituent elements in the exemplary embodiments include an element that can be easily assumed by one of ordinary skill in the art or an element that is substantially the same. In the following embodiments, a case in which a paper medium is used as an image forming medium on which an image is formed by an image forming apparatus. The image forming apparatus can be any one of a printer, a copier, a press machine, etc., which can form an image on an image forming medium.

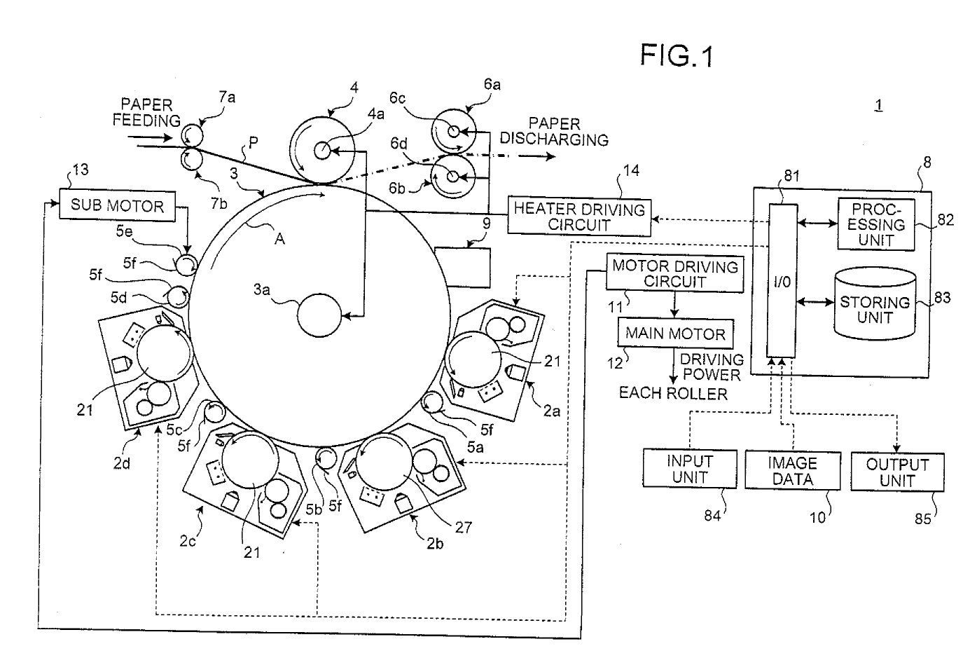

FIG. 1 is a schematic diagram of an image forming apparatus 1 according to an embodiment of the present invention. The image forming apparatus 1 includes at least one photosensitive unit, an image supporting roller 3 and a backup roller 4 as a transfer unit, a plurality of carrier removing rollers 5a, 5b, 5c, 5d, and 5e as a carrier removing unit, a pair of fixing rollers 6a and 6b as a fixing unit, a pair of paper feeding rollers 7a and 7b, a control unit 8 that functions as a carrier-removal-amount control unit, and a cleaning unit 9 that removes a residual toner image that is not transferred onto a paper medium P and remained on the image supporting roller 3. The image forming apparatus 1 includes four photosensitive units 2a, 2b, 2c, and 2d. The image forming apparatus 1 is an electrophotographic image forming apparatus that uses a liquid toner.

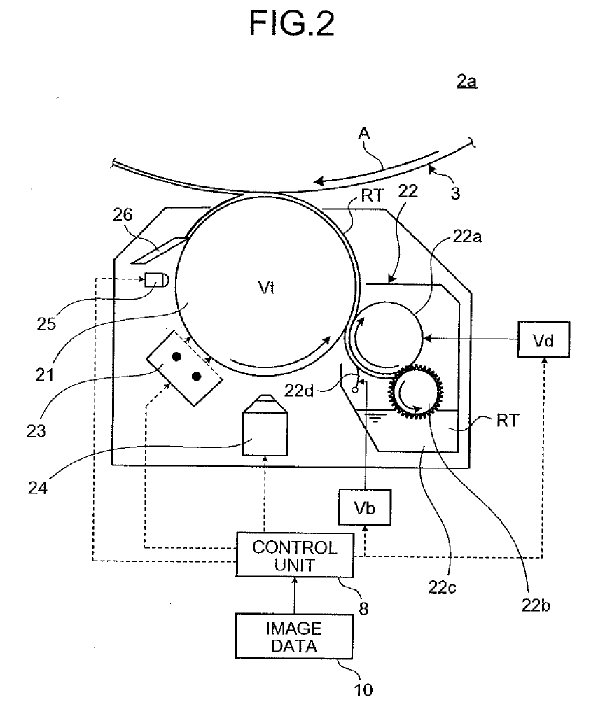

Each of the photosensitive units 2a to 2d develops a respective electrostatic latent image by using a liquid toner RT having different colors to form a single color toner image, and sequentially transfers the single color toner image onto the image supporting roller 3. The process of transferring a single color toner image onto the image supporting roller 3 is called a primary transfer. FIG. 2 is an enlarged view of the photosensitive unit 2a. The photosensitive units 2b to 2d have the same or similar configuration. The photosensitive unit 2a includes a photosensitive roller 21, a liquid-toner supplying unit 22, a charging unit 23, an exposing unit 24, a neutralizing unit 25, and a cleaner blade 26. The liquid toner RT includes resin-based toner particles T and silicon-oil-based carrier fluid S (see FIG. 4). The silicon oil is nonvolatile with a high viscosity of about 20 cst to 1000 cst. The silicon oil can include a denatured-silicon-oil-based toner-particle dispersing agent (not shown). Unlike a conventional volatile petroleum-based solvent, the nonvolatile high-viscosity silicon oil disperses the toner particle of a solid content as it is, without dissolving the toner particle.

A single color toner image is formed on the photosensitive roller 21 based on image data 10 that is input to the control unit 8. The photosensitive roller 21 is in contact with the image supporting roller 3, and rotates in the same direction as a direction of rotation of the image supporting roller 3, i.e., the direction indicated by an arrow A in FIG. 2, by a driving force of a main motor 12. The same direction means that tangential directions of rotating rollers are the same.

The liquid-toner supplying unit 22 supplies the liquid toner RT onto the photosensitive roller 21 to develop an electrostatic latent image on the photosensitive roller 21. The liquid-toner supplying unit 22 includes a developing roller 22a, a supplying roller 22b, a liquid-toner storage 22c, and a bias blade 22d.

The developing roller 22a is in contact with the photosensitive roller 21, and rotates in the same direction as the direction of rotation of the photosensitive roller 21, which is the same direction as the direction of rotation of the image supporting roller 3, by the driving force of the main motor 12. A predetermined voltage Vd is applied to the developing roller 22a by a voltage control of the control unit 8.

The supplying roller 22b is in contact with the developing roller 22a, and rotates in the same direction as the direction of rotation of the image supporting roller 3 by the driving force of the main motor 12. A part of the supplying roller 22b is soaked in the single-color liquid toner RT stored in the liquid-toner storage 22c, and a corrugated pattern is formed on the surface of the supplying roller 22b. The supplying roller 22b can supply a fixed amount of the single-color liquid toner RT to the developing roller 22a.

The liquid-toner storage 22c stores the single-color liquid toner RT of which a concentration, i.e., an amount of the toner particles T contained in the carrier fluid S is adjusted in a liquid-toner tank (not shown).

The bias blade 22d is arranged in such a manner that a tip of the bias blade 22d is at a predetermined distance from the surface of the developing roller 22a. Specifically, the bias blade 22d is arranged in such a manner that the tip of the bias blade 22d is in contact with the liquid toner RT on the surface of the developing roller 22a but not in contact with the surface of the developing roller 22a. A predetermined voltage Vb, which is higher than the predetermined voltage Vd, is applied to the bias blade 22d by a voltage control of the control unit 8.

The charging unit 23 is controlled by the control unit 8 to charge the photosensitive roller 21 with a predetermined voltage Vt that is lower than the predetermined voltage Vd. Thus, the relation between the voltages is Vb>Vd>Vt, which means that the voltages are higher in order of the bias blade 22d, the developing roller 22a, and the photosensitive roller 21.

The exposing unit 24 is controlled by the control unit 8 to form an electrostatic latent image on the photosensitive roller 21 based on the image data 10 that is input to the control unit 8.

The neutralizing unit 25 is controlled by the control unit 8, and neutralizes the electric charge on the photosensitive roller 21. When the electric charge on the photosensitive roller 21 is neutralized, an electrostatic latent image formed on the photosensitive roller 21 is erased.

The cleaner blade 26 scraps out a residual toner image that is not transferred onto the image supporting roller 3 and remained on the photosensitive roller 21 to keep the photosensitive roller 21 clean.

The image supporting roller 3 transfers, as shown in FIG. 1, single-color toner images formed on the image supporting roller 3 from each of the photosensitive rollers 21 to the paper medium P. The process of transfer of the single-color toner images from the image supporting roller 3 to the paper medium P is called a secondary transfer. The image supporting roller 3 is heated to a predetermined temperature (for example, about 60° C. to 80° C.) by a heater 3a. The image supporting roller 3 rotates in a direction indicated by the arrow A shown in FIG. 1 by the driving force of the main motor 12.

The backup roller 4 is in contact with the image supporting roller 3, and forms a nip length (a contact length of two rollers being in contact in a direction of a rotation axis) that is wider than the maximum width of the paper medium P, and a nip pressure that is enough to transfer the toner image formed on the image supporting roller 3 to the paper medium P. The backup roller 4 is heated to a predetermined temperature (for example, about 60° C. to 100° C.) by a heater 4a. The backup roller 4 rotates in the same direction as the direction of rotation of the image supporting roller 3 by the driving force of the main motor 12.

The carrier removing rollers 5a to 5e are in contact with the image supporting roller 3, and removes the carrier fluid contained in the toner image formed on the image supporting roller 3 before transferring the toner image from the image supporting roller 3 to the paper medium P. The carrier removing rollers 5a to 5e can increase a solid content ratio of the toner image, which is a ratio of the toner particle to the toner image, up to equal to or more than 50%, preferably up to equal to or more than 90%, by removing the carrier fluid contained in the toner image formed on the image supporting roller 3. The carrier removing rollers 5a to 5d are arranged on a side of the photosensitive units 2a to 2d in the direction of rotation of the image supporting roller 3, respectively. The carrier removing rollers 5a to 5d rotate in the same direction as the direction of rotation of the image supporting roller 3 by the driving force of the main motor 12. According to the present embodiment, a ratio of the a circumferential velocity of each of the carrier removing rollers 5a to 5d to a circumferential velocity of the image supporting roller 3 is kept constant.

The carrier removing roller 5e is arranged between each of the photosensitive units 2a to 2d and the carrier removing rollers 5a to 5d and a position at which the toner image formed on the image supporting roller 3 is transferred onto the paper medium P. The carrier removing roller 5e rotates in a direction opposite to the direction of rotation of the image supporting roller 3 by a driving force of a sub motor 13. By setting the direction of rotation of the carrier removing roller 5e opposite to the direction of rotation of the image supporting roller 3, it is possible to aggressively remove the carrier fluid contained in the toner image formed on the image supporting roller 3, compared to the case in which the direction of rotation of the carrier removing roller 5e is the same as the direction of rotation of the image supporting roller 3. Therefore, the carrier removing roller 5e can make the solid content ratio of the toner image formed on the image supporting roller 3 equal to or more than 95%. The opposite direction means that the tangential directions of rotating rollers are opposite.

Respective collecting blades 5f collect the carrier fluid removed from the toner image formed on the image supporting roller 3 by each of the carrier removing rollers 5a to 5d. The collected carrier fluid is used for adjusting the concentration of the liquid toner in the toner tank (not shown) or for removing the toner image remained on the image supporting roller 3 without being transferred onto the paper medium P by the cleaning unit 9.

The pair of fixing rollers 6a and 6b fix the toner image transferred onto the paper medium P by the operation of the image supporting roller 3 and the backup roller 4 on the paper medium P. The fixing of the toner image is performed by heating the toner image and the paper medium P and pressing the toner image against the paper medium P. The pair of fixing rollers 6a and 6b are in contact with each other, and forms a nip length that is wider than the maximum width of the paper medium P, and a nip pressure that is enough to press the toner image transferred onto the paper medium P against the paper medium P. The pair of fixing rollers 6a and 6b are heated to a predetermined temperature (for example, about 100° C. to 150° C.) by heaters 6c and 6d, respectively. The pair of fixing rollers 6a and 6b rotate in a direction of pulling the paper medium P that passed the nip between the image supporting roller 3 and the backup roller 4 into the nip between the pair of fixing rollers 6a and 6b by the driving force of the main motor 12. In other words, the fixing roller 6a rotates in the same direction as the direction of rotation of the image supporting roller 3, and the fixing roller 6b rotates in a direction opposite to the direction of rotation of the image supporting roller 3.

The pair of paper feeding rollers 7a and 7b feeds the paper medium P to the nip between the image supporting roller 3 and the backup roller 4. The pair of paper feeding rollers 7a and 7b are in contact with each other, and forms a nip length that is wider than the maximum width of the paper medium P, and a nip pressure that is enough to send the paper medium P to the nip between the image supporting roller 3 and the backup roller 4. The pair of paper feeding rollers 7a and 7b rotate in a direction of pulling the paper medium P into a nip between the pair of paper feeding rollers 7a and 7b by the driving force of the main motor 12. In other words, the paper feeding roller 7a rotates in the same direction as the direction of rotation of the image supporting roller 3, and the paper feeding roller 7b rotates in a direction opposite to the direction of rotation of the image supporting roller 3.

The control unit 8 controls the operation of the image forming apparatus 1. Specifically, the control unit 8 controls an amount of the carrier fluid, contained in the toner image formed on the image supporting roller 3, to be removed by the carrier removing rollers 5a to 5d before transferring the toner image formed on the image supporting roller 3 to the paper medium P. The control unit 8 includes an input/output (I/O) unit 81, a processing unit 82, and a storing unit 83. An input unit 84 and an output unit 85 are connected to the control unit 8. The input unit 84 performs an input of a command for starting an image formation on the paper medium P by the image forming apparatus 1, a control command for the image forming apparatus 1 such as a selection command for selecting a paper quality and a paper thickness of the paper medium P, and data, via the I/O unit 81. The input unit 84 is an input device, such as a keyboard, a mouse, or a microphone.

The processing unit 82 is the carrier-removal-amount control unit, including a memory (not shown) such as a random access memory (RAM) and a read only memory (ROM), and a central processing unit (CPU) (not shown). When the image forming apparatus 1 starts an image formation, the processing unit 82 loads a computer program (hereinafter, “image forming program”) into a memory (not shown) of the processing unit 82, and performs a necessary operation. The processing unit 82 stores a halfway result of the operation as necessary in the storing unit 83, and reads out the stored result from the storing unit 83 to perform the operation.

The image data 10 for an image to be formed on the paper medium P is input to the control unit 8. The image data 10 can be data read by an image reading apparatus, data recorded by a digital camera, or data created by an application of a personal computer (PC) such as a word processor software and a drawing software. The control unit 8 displays the image data 10 on the output unit 85 via the I/O unit 81. The output unit 85 is a display device such as a cathode ray tube (CRT) or a liquid crystal display (LCD).

The storing unit 83 stores the image forming program. When the image forming program is executed, the image forming method is implemented on the image forming apparatus 1. The storing unit 83 is a fixed disk device such as a hard disk device, a flexible disk (FD), an optical magnetic disk, a nonvolatile memory such as a flash memory (a read-only storage medium such as a compact disk-read only memory (CD-ROM)), a storage device including a volatile memory such as a RAM, or a combination of the above devices. The storing unit 83 can be installed in the processing unit 82 or in other devices (for example, a database server). Alternatively, a terminal apparatus in which the input unit 84 and the output unit 85 are installed can access the image forming apparatus 1 via a wired connection or a wireless connection.

The image forming program is not necessarily to stand alone, but can achieve a desired function by cooperating with a computer program installed in advance in a computer system, for example, a separate computer program such as an operating system (OS). Alternatively, the image forming program for realizing the function of the processing unit 82 can be stored in a computer-readable recording medium, so that a computer system can load the image forming program stored in the recording medium, and execute the image forming program to perform an image formation on the paper medium P by the image forming apparatus 1 according to the present invention. The computer system includes the OS and a hardware such as a peripheral.

According to the present embodiment, each of the image supporting roller 3, the backup roller 4, the photosensitive roller 21, the developing roller 22a, the supplying roller 22b, the carrier removing rollers 5a to 5d is coupled to the main motor 12, and rotates in synchronization with each other by the driving force of the main motor 12. The carrier removing roller 5e is not coupled to the main motor 12 but it is coupled to the sub motor 13. The rotation driving of the main motor 12 is performed by a motor driving circuit 11. However, the present invention is not limited to the above scheme, i.e., each of the rollers can be coupled to a dedicated independent motor so that each of the rollers, and the control unit 8 is configured to control each of those motors via the motor driving circuit 11 so that all the motors can rotate in synchronization with each other.

The rotation driving of the sub motor 13 is also controlled by the motor driving circuit 11 as in the case of the main motor 12. The control unit 8 performs a control of a rotation speed of the sub motor 13 via the motor driving circuit 11. In other words, a rotation speed of the carrier removing roller 5e, i.e., a ratio of a circumferential velocity of the carrier removing roller 5e to a circumferential velocity of the image supporting roller 3 is controlled by the control unit 8.

Heating of each of the image supporting roller 3, the backup roller 4, the fixing roller 6a, and the fixing roller 6b by each of the heaters 3a, 4a, 6c, and 6d is performed by a heater driving circuit 14. The control unit 8 controls a heating amount of each of the heaters 3a, 4a, 6c, and 6d via the heater driving circuit 14. Each of the image supporting roller 3, the backup roller 4, the fixing roller 6a, and the fixing roller 6b is coupled to the main motor 12, an rotates in sync with each other by the driving force of the main motor 12. The rotation driving of the main motor 12 is performed by the motor driving circuit 11. In other words, a temperature of each of the image supporting roller 3, the backup roller 4, the fixing roller 6a, and the fixing roller 6b is controlled by the control unit 8.

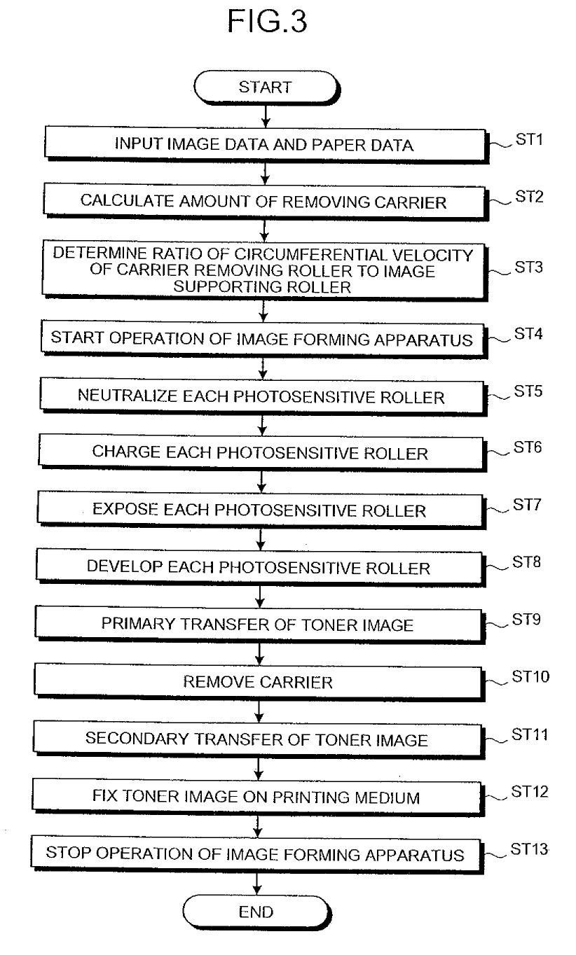

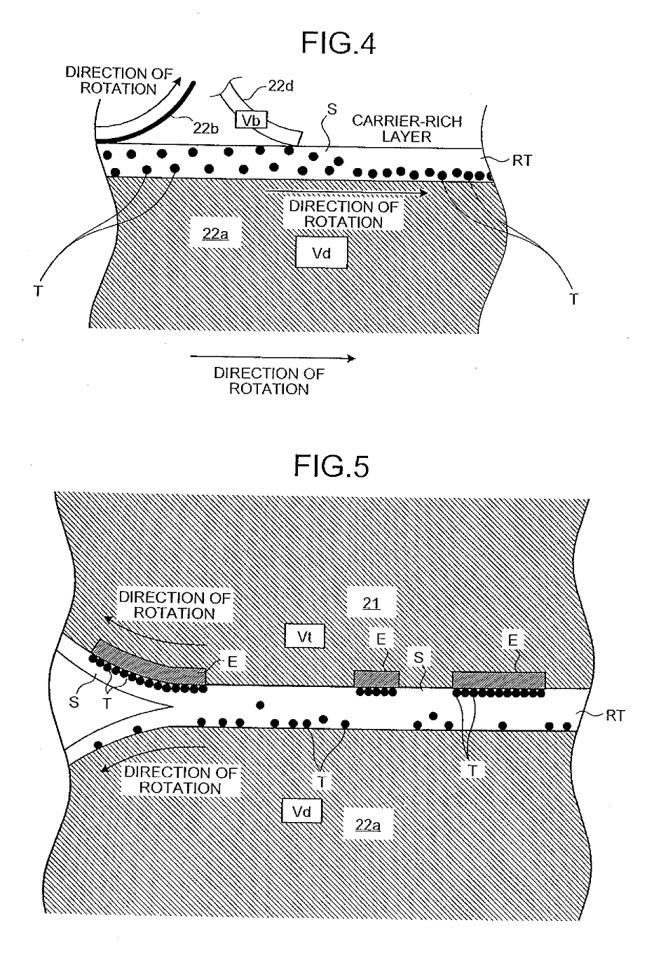

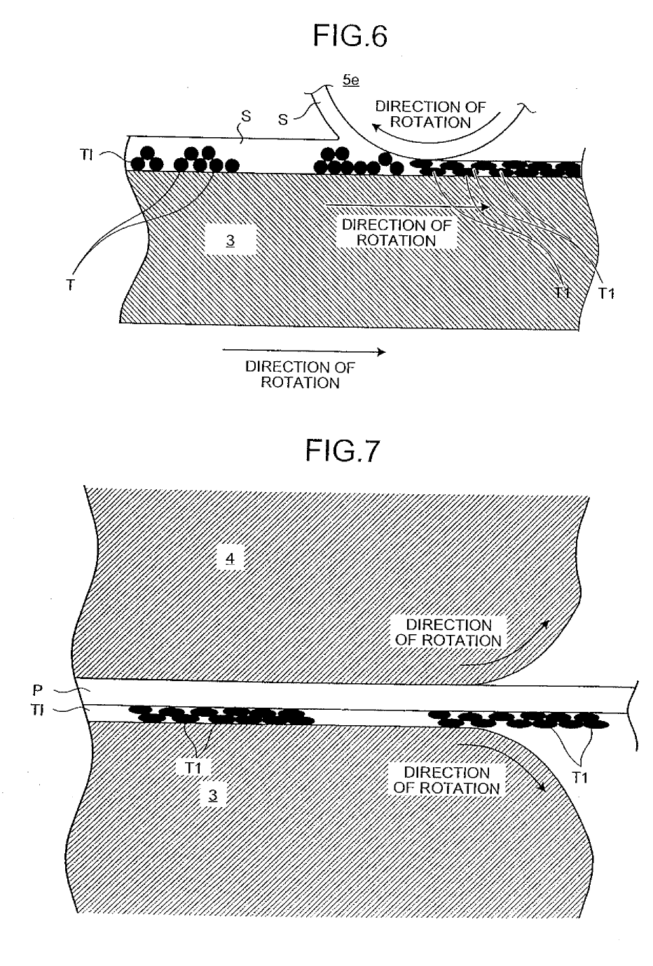

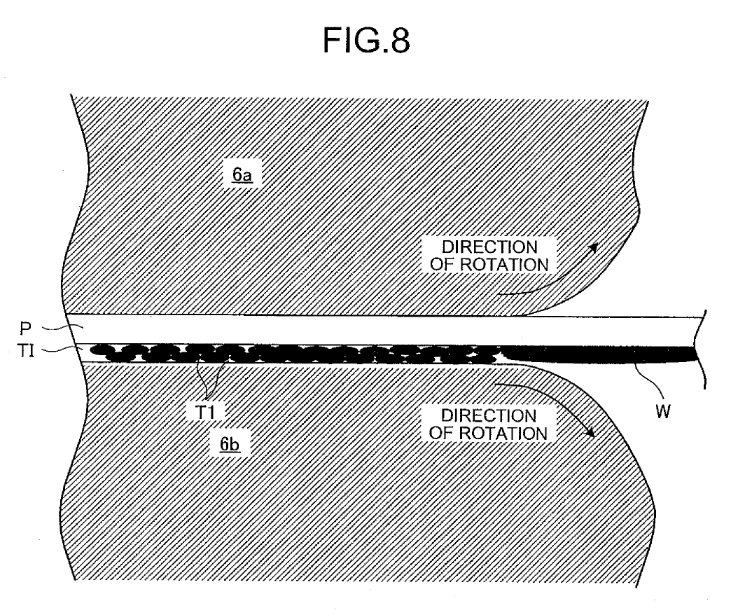

FIG. 3 is a flowchart of a process of forming an image performed by the image forming apparatus 1. FIG. 4 is a schematic diagram for illustrating a state of the liquid toner RT when passing the bias blade 22d. FIG. 5 is a schematic diagram for illustrating a state of the liquid toner RT at a developing time. FIG. 6 is a schematic diagram for illustrating a state of a toner image on the image supporting roller 3 at a carrier removing time. FIG. 7 is a schematic diagram for illustrating a state of the toner image on the paper medium P at a transferring time. FIG. 8 is a schematic diagram for illustrating a state of the toner image on the paper medium P at a fixing time.

The quality of the paper medium P can vary based on a degree of coating and a surface roughness. For example, such as a cast-coated paper, a gloss-coated paper, a matt-coated paper, and micro-coated paper have different qualities. Moreover, the mount of the carrier fluid that the paper medium P can absorb is different according to the degree of coating and the surface roughness. For example, the degree of coating becomes low in order of the micro-coated paper, the matt-coated paper, the gloss-coated paper, and the cast-coated paper, and the amount of the carrier fluid that can be absorbed decreases in the same order. Furthermore, the thickness of the paper medium P can vary. A maximum amount of the carrier fluid that the paper medium P can absorb varies according to the thickness. According to the quality and the thickness of the paper medium P, even if the carrier fluid is remained when removing the carrier fluid contained in the toner image by the carrier removing rollers 5a to 5e, the carrier fluid may be absorbed by the paper medium P so that the carrier fluid included in the toner image transferred onto the paper medium P becomes remarkably low. If this happens, the carrier fluid cannot function as the release agent any more, resulting in an occurrence of the offset phenomenon. Therefore, in the image forming apparatus 1, the amount of removing the carrier by the carrier removing rollers 5a to 5e, i.e., the ratio of the circumferential velocity of the carrier removing roller 5e to the circumferential velocity of the image supporting roller 3 in the present embodiment, is controlled based on the quality and the thickness of the paper medium P.

First of all, the image data 10 and paper medium data are input to the control unit 8 by a user (Step ST1). The control unit 8 acquires the image data 10 for an image to be formed on the paper medium P by the image forming apparatus 1 and data of the paper medium P on which the image is formed. The data of the paper medium P is the quality and the thickness of the paper medium P. The data of the paper medium P can be acquired by displaying the quality and the thickness of a plurality of paper mediums P on the output unit 85 by the control unit 8 before starting an operation of the image forming apparatus 1 and prompting the user to select desired quality and thickness.

The processing unit 82 of the control unit 8 calculates the amount of removing the carrier based on the input data of the paper medium P (Step ST2). In this example, the processing unit 82 calculates the amount of removing the carrier based on the quality and the thickness of the paper medium P on which the image is formed. For instance, by storing a carrier-removal-amount map based on the quality and the thickness of the paper medium P in the storing unit 83 of the control unit 8 in advance, the processing unit 82 calculates the amount of removing the carrier based on the carrier-removal-amount map and the input data of the paper medium P. The amount of removing the carrier is calculated so that the solid content ratio of the toner image is within a range between about 60% and 95%. The processing unit 82 calculates the amount of removing the carrier so that the amount of removing the carrier decreases with an increase of the quality, which is the degree of coating and the surface roughness, and the thickness of the paper medium P. In other words, with an increase of the quality, which is the degree of coating and the surface thickness, and the thickness of the paper medium P, a residual amount of the carrier fluid contained in the toner image on the paper medium increases at a time of fixing the toner image on the paper medium P by the pair of fixing rollers 6a and 6b. With this scheme, the control unit 8 can arbitrarily control the residual amount of the carrier fluid according to the type of the paper medium P, so that the offset phenomenon can be suppressed and a degradation of the quality of the image formed on the paper medium P can be suppressed at the same time.

Then, the processing unit 82 calculates the ratio of the circumferential velocity of the carrier removing roller 5e to the circumferential velocity of the image supporting roller 3 based on the calculated amount of removing the carrier (Step ST3). The direction of rotation of the carrier removing roller 5e is opposite to the direction of rotation of the image supporting roller 3; and therefore, it is possible to aggressively remove the carrier fluid contained in the toner image formed on the image supporting roller 3. The amount of removing the carrier by each of the carrier removing rollers 5a to 5e can be changed by changing the ratio of the circumferential velocity of each of the carrier removing rollers 5a to 5e to the circumferential velocity of the image supporting roller 3. In this example, the amount of removing the carrier is changed by keeping the ratio of the circumferential velocity of each of the carrier removing rollers 5a to 5d to the circumferential velocity of the image supporting roller 3 constant, and changing the ratio of the circumferential velocity of the carrier removing rollers 5e to the circumferential velocity of the image supporting roller 3. In other words, by increasing the ratio of the circumferential velocity of the carrier removing rollers 5e to the circumferential velocity of the image supporting roller 3, it is possible to decrease the residual amount of the carrier fluid contained in the toner image formed on the image supporting roller 3 after passing the carrier removing rollers 5e. Therefore, for instance, the processing unit 82 calculates that the thickness of the paper medium P is constant, the ratio of the circumferential velocity=1 for the micro-coated paper, the ratio of the circumferential velocity=2 for the matt-coated paper, the ratio of the circumferential velocity=3 for the gloss-coated paper, and the ratio of the circumferential velocity=4 for the cast-coated paper.

After calculating the ratio of the circumferential velocity, the processing unit 82 starts an operation of the image forming apparatus 1 (Step ST4). The processing unit 82 performs the rotation driving of the main motor 12 and the sub motor 13 via the motor driving circuit 11 to drive each of the rollers. The rotation driving of the sub motor 13 is performed based on the amount of removing the carrier calculated by the processing unit 82, and the carrier removing rollers 5e rotates at a ratio of the circumferential velocity of the carrier removing roller 5e to the circumferential velocity of the image supporting roller 3 calculated based on the calculated amount of removing the carrier. With the rotation driving of the main motor 12, as shown in FIG. 4, the single-color liquid toner RT stored in the liquid-toner storage 22c is supplied to the developing roller 22a of each of the photosensitive units 2a to 2d by the supplying roller 22b. The single-color liquid toner RT supplied to the developing roller 22a includes the toner particle T evenly in the carrier fluid S.

The processing unit 82 applies the predetermined voltage Vb and the predetermined voltage Vd to the bias blade 22d and the developing roller 22a, respectively. The applied voltages generate an electric field between the bias blade 22d and the developing roller 22a, and the toner particle T is charged and moves to the side of the developing roller 22a in the liquid toner RT (electrophoresis). Therefore, a state of the single-color liquid toner RT on the developing roller 22a that passed the bias blade 22d is changed from a state in which the toner particle T is evenly contained in the carrier fluid S to a state in which a toner-rich layer is formed on the side of the developing roller 22a and a carrier-rich layer is formed on the side opposite to the developing roller 22a.

The processing unit 82 neutralizes the photosensitive roller 21 of each of the photosensitive units 2a to 2d (Step ST5). In this example, the processing unit 82 neutralizes the photosensitive roller 21 by driving the neutralizing unit 25. With this mechanism, the electrostatic latent image formed on the photosensitive roller 21 is erased.

Then, the processing unit 82 charges the photosensitive roller 21 of each of the photosensitive units 2a to 2d (Step ST6). In this example, the processing unit 82 charges the photosensitive roller 21 by driving the charging unit 23.

After charging the photosensitive roller 21, the processing unit 82 exposes the photosensitive roller 21 of each of the photosensitive units 2a to 2d (Step ST7). In this example, the processing unit 82 exposes the photosensitive roller 21 by driving the exposing unit 24, to an electrostatic latent image (indicated by E in FIG. 5) based on the image data 10, which is input to the control unit 8, on the photosensitive roller 21.

After that, the photosensitive roller 21 of each of the photosensitive units 2a to 2d is developed (Step ST8). The single-color liquid toner RT on the developing roller 22a, which is in the state in which a toner-rich layer is formed on the side of the developing roller 22a and a carrier-rich layer is formed on the side opposite to the developing roller 22a after passing the bias blade 22d, is brought into contact with the photosensitive roller 21. There is a potential difference of the predetermined voltage Vd and the predetermined voltage Vt between the photosensitive roller 21 and the developing roller 22a. Therefore, as shown in FIG. 5, the positively-charged toner particle T contained in the single-color liquid toner RT is attracted by the electrostatic latent image E on the photosensitive roller 21, and attached to a portion of the photosensitive roller 21 where the electrostatic latent image E is formed. With this mechanism, the developing of the photosensitive roller 21 is performed, and a single-color toner image Ti based on the image data 10 is formed on the photosensitive roller 21.

Subsequently, a primary transfer of the toner image is performed between the photosensitive roller 21 of each of the photosensitive units 2a to 2d and the image supporting roller 3 (Step ST9). In this example, the single-color toner image Ti formed on the photosensitive roller 21 is transferred onto the image supporting roller 3. For instance, the image supporting roller 3 is grounded or set to be a voltage lower than the predetermined voltage Vt, so that a potential difference between the photosensitive roller 21 and the image supporting roller 3, i.e., a potential difference between the predetermined voltage Vt and the voltage of the image supporting roller 3, is generated. Then, the positively-charged toner particle T contained in the single-color toner image Ti is attracted from the electrostatic latent image E on the photosensitive roller 21 to the image supporting roller 3, and attached to the image supporting roller 3. As a result, the single-color toner image Ti is superimposed on the image supporting roller 3, so that the toner image TI based on the image data 10 is transferred onto the image supporting roller 3.

After the primary transfer is performed, a carrier removal is performed by the carrier removing rollers 5a to 5e (Step ST10). In this example, the carrier fluid S included in the toner image TI formed on the image supporting roller 3 is removed by attaching the carrier fluid S to the carrier removing rollers 5a to 5e that are in contact with the image supporting roller 3. Particularly, as shown in FIG. 6, the carrier removing roller 5a rotates in the direction opposite to the direction of rotation of the image supporting roller 3; and therefore, the carrier removing roller 5a can scrap out more carrier fluid S contained in the toner image TI formed on the image supporting roller 3. At this moment, the toner particle T contained in the toner image TI formed on the image supporting roller 3 is heated because the image supporting roller 3 is heated to a predetermined temperature by the heater 3a. Therefore, the toner particle T is in a semi-melting state, which means that it can be easily deformed. Thus, the heated toner particle T is crushed while passing through the nip between each of the carrier removing rollers 5a to 5e and the image supporting roller 3, and becomes a deformed toner particle T1. Because a space between the deformed toner particles T1 is narrower than a space between the toner particles T before being deformed, the carrier fluid existed in the space between the toner particles T before being deformed is squeezed, so that the removal of the carrier fluid S contained in the toner image TI by the carrier removing rollers 5a to 5e is expedited. Because the ratio of the circumferential velocity of the carrier removing roller 5e to the circumferential velocity of the image supporting roller 3 is the value calculated above, an amount of the carrier fluid S remained in the toner image TI formed on the image supporting roller 3 after passing the carrier removing roller 5e, i.e., the residual amount, depends on the calculated amount of removing the carrier.

After the carrier is removed, a secondary transfer of the toner image is performed between the image supporting roller 3 and the paper medium P (Step ST11). In this example, the toner image TI formed on the image supporting roller 3 is transferred onto the paper medium P. The deformed toner particle T1 that is crushed by the carrier removing rollers 5a to 5e keeps the semi-melted state even after passing the carrier removing roller 5e, because of the heating by the heater 3a. Therefore, as shown in FIG. 7, when the toner image TI formed on the image supporting roller 3 is brought into contact with the paper medium P, the deformed toner particle T1 is further crushed between the image supporting roller 3 and the backup roller 4, attached to the paper medium P, to transfer the toner image TI formed on the image supporting roller 3 onto the paper medium P. At this moment, the residual amount of the carrier fluid S based on the amount of removing the carriers by the carrier removing rollers 5a to 5e is present in the toner image TI transferred onto the paper medium P.

After the secondary transfer of the toner image is performed, a fixing of the toner image TI to the paper medium P is performed by the pair of fixing rollers 6a and 6b (Step ST12). In this example, as shown in FIG. 8, the paper medium P onto which the toner image TI is transferred passes through the nip between the pair of fixing rollers 6a and 6b that are heated to a predetermined temperature by the heaters 6c and 6d, respectively, so that the paper medium P and the toner image TI are pressed and heated. Then, the toner image TI is fixed to the paper medium P, and an image W is formed on the paper medium P. At this moment, the carrier fluid S contained in the toner image TI on the paper medium P from the primary transfer to the secondary transfer is absorbed by the paper medium P according to the quality and the thickness of the paper medium P. The residual amount of the carrier fluid S contained in the toner image TI transferred onto the paper medium P is the value based on the amount of removing the carrier taking an amount of absorbing the carrier fluid S by the paper medium P into consideration.

Therefore, in the toner image TI transferred onto the paper medium P, an amount of the carrier fluid S is remained, with which it is possible to reduce an adherence of the toner image TI to the fixing roller 6b that makes contact with the toner image TI, having the same function as the release agent, such as the silicon oil applied to the roller that makes contact with the toner image TI transferred onto the paper medium P in the conventional technology, when the paper medium P and the toner image TI pass through the nip between the pair of fixing rollers 6a and 6b.

In the carrier fluid S, not only the silicon oil, but also the denatured silicon oil is included, which is attached to the toner particle T before being denatured as the toner-particle dispersing agent. In other words, even if a trial is performed to remove all the carrier fluid S contained in the toner image TI before being transferred onto the paper medium P by the carrier removing rollers 5a to 5e, it ends up with a small amount of the denatured silicon oil left as the carrier fluid S. Even if the toner particle T is crushed in the semi-melted state to become the deformed toner particle T1, the denatured silicon oil keeps a state of being attached to the deformed toner particle T1. Therefore, it is also possible to reduce the adherence of the Toner image TI, which is to attach to the fixing roller 6b, by the denatured silicon oil. As a result, the offset phenomenon can be suppressed without applying the release agent on the fixing roller 6b.

Furthermore, because the carrier fluid S contained in the toner image TI transferred onto the paper medium P is used as the release agent, a formation of the image W having an unnatural glossiness on the paper medium P can be suppressed, compared to a case in which the release agent applied on the fixing roller 6b is attached to the toner image TI transferred onto the paper medium P. As a result, it is possible to suppress a degradation of quality of the image W.

The carrier fluid S that functions as the release agent is contained in the toner image TI transferred onto the paper medium P only, which means that the carrier fluid S is not attached to a portion other than the toner image TI on the paper medium P. As a result, it is possible to suppress leaving a feeling of an oily sheen on the paper medium P.

In the conventional image forming apparatus, the offset phenomenon can be suppressed without applying the release agent by using a powder toner mixed with a low-molecular weight wax component. However, after a fixing process, the wax component is remained on the image W, which leads to leaving a feeling of residual wax on the paper medium P. It is because the conventional image forming apparatus cannot adjust an amount of the wax component contained in the toner image TI right before the fixing process, and an amount of mixing the wax component with respect to the powder toner must be set to an amount that is needed by the paper medium P that most requires the wax. If the amount of mixing the wax component is reduced to suppress the feeling of the residual wax, there is a limitation in selecting the paper medium on which the image W is formed.

However, the liquid toner TR used in the image forming apparatus according to the present invention is not in a state in which the toner particle T that is a solid content is dissolved to be dispersed by the carrier fluid S that is nonvolatile high-viscosity silicon oil, but is in a state in which the toner particle T is dispersed in the carrier fluid S as it is. Therefore, it is possible to remove the carrier fluid S from the toner particle T with ease, with an easy control of the amount of removing the carrier fluid S. With this scheme, because the amount of removing the carrier fluid S, i.e., the residual amount of the carrier fluid S contained in the toner image TI transferred onto the image forming medium, can be easily controlled, the feeling of oily sheen of the image W can be suppressed. In addition, a wide selection of the image forming medium on which an image is formed by the image forming apparatus 1, i.e., a wide selection of the available image forming medium, can be achieved.

Finally, when the paper medium P on which the image W is formed passes the pair of fixing rollers 6a and 6b and discharged from the image forming apparatus 1, the processing unit 82 stops the operation of the image forming apparatus 1 (Step ST13). With above procedures, the image W is formed on the paper medium P by the image forming apparatus 1.

According to the present embodiment, although the control unit 8 as the carrier-removal-amount control unit controls the ratio of a circumferential velocity of a part of the carrier removing rollers 5a to 5e (the carrier removing roller 5e) to a circumferential velocity of the image supporting roller 3 only, the present invention is not limited to the above scheme. When the carrier removing rollers 5a to 5e rotate in a direction opposite to the direction of rotation of the image supporting roller 3, it is possible to remarkably increase the amount of removing the carrier, compared to the case in which the directions of rotation are the same, so that the residual amount of the carrier fluid S contained in the toner image TI on the image supporting roller 3 after passing the carrier removing roller 5e can be reduced. In addition, the carrier removing rollers 5a to 5e can also reduce the residual amount of the carrier fluid S by increasing the ratio of circumferential velocity to the image supporting roller 3. Therefore, the control unit 8 can control the ratio of circumferential velocity of the carrier removing rollers 5a to 5e to the image supporting roller 3 according to the calculated amount of removing the carrier. Furthermore, the control unit 8 can control the direction of rotation of the carrier removing rollers 5a to 5e with respect to the direction of rotation of the image supporting roller 3 according to the calculated amount of removing the carrier.

Moreover, it is also possible to reduce the residual amount of the carrier fluid S by setting a voltage of the carrier removing rollers 5a to 5e higher than a voltage of the image supporting roller 3 and increasing potential difference between the carrier removing rollers 5a to 5e and the image supporting roller 3. Therefore, the control unit 8 can control the voltage difference between the carrier removing rollers 5a to 5e and the image supporting roller 3 according to the calculated amount of removing the carrier while applying a constant voltage to each of the carrier removing rollers 5a to 5e.

Furthermore, it is also possible to reduce the residual amount of the carrier fluid S by increasing the nip pressure of the carrier removing rollers 5a to 5e with respect to the image supporting roller 3. Therefore, with an arrangement of an adjusting unit that adjusts the nip pressure of the carrier removing rollers 5a to 5e with respect to the image supporting roller 3, the control unit can control the nip pressure of the carrier removing rollers 5a to 5e with respect to the image supporting roller 3 via the adjusting unit according to the calculated amount of removing the carrier.

A viscosity of the toner image TI on the image supporting roller 3 changes depending on a temperature of the toner image TI. Therefore, it is possible to cause the carrier removing rollers 5a to 5e to easily scrap out the carrier fluid S contained in the toner image TI by increasing the temperature of the toner image TI on the image supporting roller 3 to decrease the viscosity of the toner image TI, and as a result, the residual amount of the carrier fluid S can be reduced. Therefore, the control unit 8 can control the heater 3a that heats the image supporting roller 3 according to the calculated amount of removing the carrier.

In addition, the control unit 8 can control the direction of rotation of the carrier removing rollers 5a to 5e, the ratio of circumferential velocity of the carrier removing rollers 5a to 5e to the circumferential velocity of the image supporting roller 3, the voltage difference between the carrier removing rollers 5a to 5e and the image supporting roller 3, the nip pressure of the carrier removing rollers 5a to 5e with respect to the image supporting roller 3, or a temperature of the toner image according to the calculated amount of removing the carrier.

According to the present embodiment, although the number of carrier removing rollers (the carrier removing rollers 5a to 5e) that make contact with the image supporting roller 3 is fixed, and only a ratio of circumferential velocity of a part of the carrier removing rollers 5a to 5e (the carrier removing roller 5e) to circumferential velocity of the image supporting roller 3 is controlled according to the calculated amount of removing the carrier, the present invention is not limited to the above scheme. If the number of the carrier removing rollers that make contact with the image supporting roller 3 is increased, it is possible to reduce the residual amount of the carrier fluid S remained in the toner image TI transferred onto the paper medium P. In other words, the amount of removing the carrier can be controlled with the number of the carrier removing rollers. Therefore, for instance, when the image forming apparatus 1 forms an image on only one type of paper medium P, because the amount of removing the carrier according to the quality and the thickness of the paper medium P is constant, the number of the carrier removing rollers according to the constant amount of removing the carrier can be set to make contact with the image supporting roller 3. Then, the residual amount of the carrier fluid S can be controlled with a simple configuration.

Furthermore, with an arrangement of a connecting/disconnecting unit that performs connection and disconnection of each of the carrier removing rollers with the image supporting roller 3, the control unit 8 can control the connection and disconnection of the carrier removing rollers with the image supporting roller 3 via the connecting/disconnecting unit according to the calculated amount of removing the carrier.

As described above, according to an embodiment of the present invention, it is possible to leave a carrier fluid that is capable of reducing an adherence of a toner image to a fixing unit, as the same function as a release agent that is applied on the fixing unit. Therefore, an image forming apparatus that can suppress an offset phenomenon can be provided without applying the release agent on the fixing unit.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a removing unit that removes a predetermined amount of carrier fluid contained in a toner image thereby obtaining a carrier-fluid removed toner-image, the toner image being formed by a liquid toner having nonvolatile high-viscosity silicon oil as the carrier fluid;
a transfer unit that transfers the carrier-fluid removed toner-image onto an image forming medium; and
a fixing unit that fixes the carrier-fluid removed toner-image on the image forming medium to the image forming medium.

2. The image forming apparatus according to claim 1, wherein
the transfer unit includes a first roller that supports the toner image and the carrier-fluid removed toner-image until the carrier-fluid removed toner-image is transferred onto the image forming medium,
the removing unit includes a plurality of second rollers capable of making contact with or separating from the first roller, and remove the predetermined amount of the carrier fluid contained in the toner image, and
number of the second rollers that make contact with the first roller is adjusted based on the predetermined amount.

3. The image forming apparatus according to claim 1, wherein
the transfer unit includes a first roller that supports the toner image and the carrier-fluid removed toner-image until the carrier-fluid removed toner-image is transferred onto the image forming medium, wherein
the removing unit includes
at least one second roller that makes contact with the first roller, and removes the predetermined amount of the carrier fluid contained in the toner image; and
a control unit that controls the amount of the carrier fluid to be removed by the second roller.

4. The image forming apparatus according to claim 3, wherein
the control unit controls at least any one of direction of rotation of the second roller, ratio of circumferential velocity of the second roller to circumferential velocity of the first roller, a voltage difference between the second roller and the first roller, nip pressure of the second roller with respect to the first roller, and temperature of the toner image and the carrier-fluid removed toner-image.

5. The image forming apparatus according to claim 3, wherein the control unit controls the amount of the carrier fluid to be removed based on at least one of a quality and a thickness of the image forming medium.

6. The image forming apparatus according to claim 1, wherein the liquid toner includes
a toner particle formed of a resin; and
the carrier fluid that includes toner-particle dispersing agent formed of denatured silicon oil.

7. An image forming method comprising:
removing a predetermined amount of carrier fluid contained in a toner image thereby obtaining a carrier-fluid removed toner-image, the toner image being formed by a liquid toner having nonvolatile high-viscosity silicon oil as the carrier fluid;
transferring the carrier-fluid removed toner-image onto an image forming medium; and
fixing the carrier-fluid removed toner-image on the image forming medium to the image forming medium.
